(19) United States
(12) Patent Application Publication
(10) Pub. No.: US 2014/0053128 A1
(43) Pub. Date: Feb. 20, 2014

(54) PERSISTING STATE USING SCRIPTS

(71) Applicants: Vadim Kuper, Yoqneam Elit (IL); Dima Stopel, Herzliya Merkaz (IL)

(72) Inventors: Vadim Kuper, Yoqneam Elit (IL); Dima Stopel, Herzliya Merkaz (IL)

(73) Assignee: Microsoft Corporation, Redmond, WA (US)

(21) Appl. No.: 13/584,823

(22) Filed: Aug. 14, 2012

(51) Int. Cl. G06F 9/44

(52) U.S. Cl. 717/106

(57) ABSTRACT

Architecture that creates a single path for modifying and persisting application's state, via scripts. Accordingly, an application utilizes one or more scripts that include statements that alter the application state. The scripts can be executed at application startup, and thus, the application resumes functioning in the desired state. No additional persistence is required, since the scripts perform this function. If there is an additional need to synchronize (or modify) application state with the server (or another remote party), only a single storage for scripts needs to be synchronized (updated), rather than individual system components.

### BACKGROUND

Modern applications operate on various types of entities, which are typically persisted so that when the application loads, the application can restore its state. Multiple types of entities are usually stored in different storage components (e.g., separate files, tables, databases, etc.); thus, multiple persistence schemes are required. Furthermore, the synchronization and/or modification of application state with or by a server introduce additional complexities such that each storage component/type needs to be synchronized (updated) individually.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture creates a single path for modifying and persisting application's state, via scripts. Accordingly, an application utilizes one or more scripts that include statements that alter the application state. The scripts can be executed at application startup, and thus, the application resumes functioning in the desired state. No additional persistence is required, since the scripts perform this function. If there is an additional need to synchronize (or modify) application state with the server (or another remote party), only a single storage for scripts needs to be synchronized (updated), rather than individual system components.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system of application state scripting for multiple applications.

FIG. 3 illustrates a system where a mobile device employs the scripting and storage of application state.

FIG. 4 illustrates the single storage location that stores both simple scripts and scripts with logic.

FIG. 5 illustrates a method in accordance with the disclosed architecture.

FIG. 6 illustrates an alternative method in accordance with the disclosed architecture.

FIG. 7 illustrates a block diagram of a computing system that executes script creation and retrieval in a single storage location in accordance with the disclosed architecture.

### DETAILED DESCRIPTION

The disclosed architecture is a single storage/persistence technology using scripts. A script language is a programming language written for the automation of tasks, and without compiled and linked steps. The script language referred to herein is intended to be human-readable, rather than “cryptic” custom data formats and languages intended for computer processing; and hence, is easily writeable and understandable. It is to be appreciated, however, that the disclosed architecture is not limited to easily readable human script languages, but applies equally to other data formats and languages. An application's persistent state can be represented as a script or a collection of scripts on the single storage. Scripts are then loaded to recreate prior application state and configuration. Synchronizing (updating) state with remote parties can be performed by synchronizing scripts, rather than data objects.

More specifically, application persistent state is represented by one or more scripts that are then executed (e.g., in a defined order) to recreate the desired state of the application. This eliminates the need to use multiple storage locations/components, since all of the application's data is restored by executing a sequence of state-altering statements loaded from the scripts. In order to save the application state (e.g., upon termination) the application can generate the script (or several scripts) that contain the exact steps (and data) to recreate the state. In other words, not all applications must regenerate and save new scripts—an application may only read the scripts.

Furthermore, if application state is to be synchronized/backed-up to a remote party, there is only a single storage location that needs to be processed.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

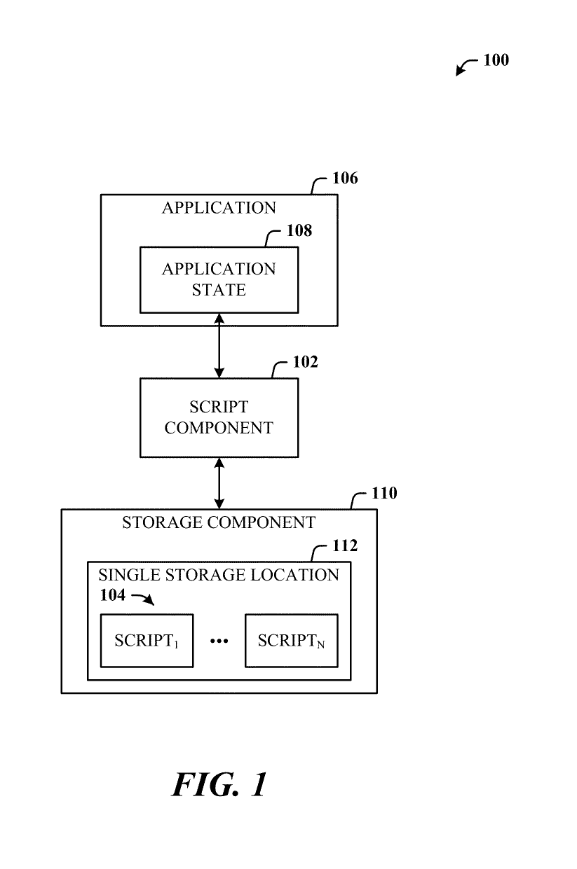

FIG. 1 illustrates a system 100 in accordance with the disclosed architecture. The system 100 can include a script component 102 that creates one or more scripts 104 of an application 106, the one or more scripts 104 persist application state 108. A storage component 110 stores the one or more scripts 104 of the application 106 as a single storage location 112 for retrieval and execution to recreate the state 108 of the application 106. As shown the script component 102 resides outside the application 106; however, alternatively, it is to be understood that the script component 102 can be part of the application 106. Thus, each application (e.g., application 106) can include its own script component.

At some other time, the script component 102 can retrieve the one or more scripts 104 from the single storage location 112 and runs the one or more scripts 104 to recreate the state 108 of the application 106 for application execution. The script component 102 can updates the one or more scripts 104 from a remote entity such as a server or other storage system. The script component 102 can synchronize a script with an updated or an older script before recreating the application state 108 of the application 106. The script component 102 automatically creates a script to include logic, which logic executes when running the script.

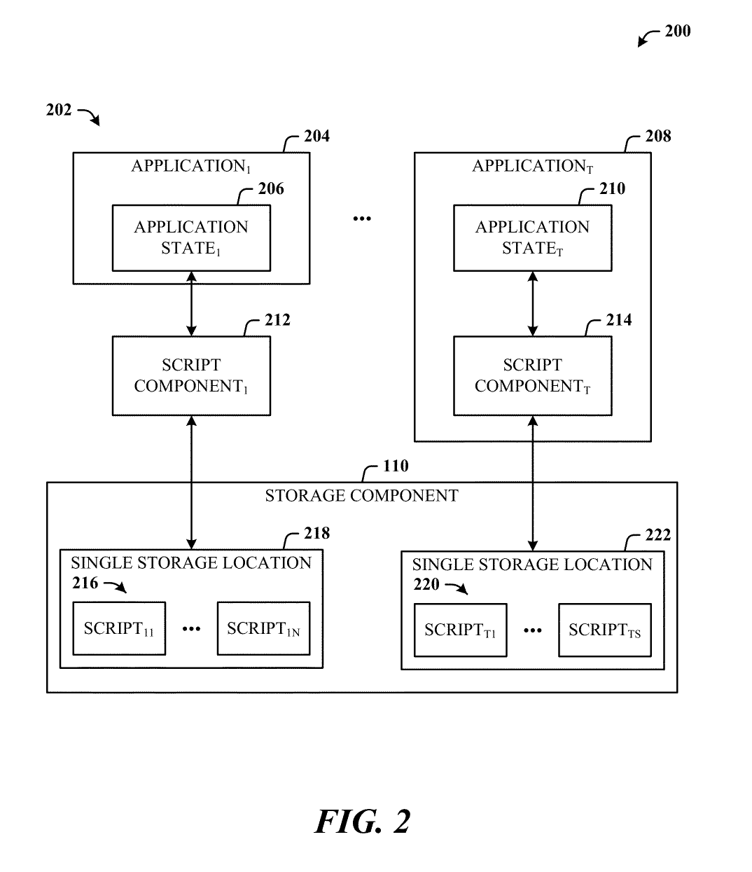

FIG. 2 illustrates a system 200 of application state scripting for multiple applications 202. A first application 204 has first application state 206 and a Tth application 208 has Tth application state 210. The first application 204 uses a first script component 212 to perform auto-scripting of application state 206, which is external to the first application 204. The Tth application 208 includes a Tth script component 214 to handle its own state persistence via scripting. It can also be the case that the applications 202 all use a single script component suitable for auto-scripting all or selected application state of the applications 204.

The script components create scripts of application state for multiple applications, and the storage component 110 stores the scripts of a given application in a separate storage location. Accordingly, the first script component 212 directs one or more scripts 216 to a first single storage location 218, and the Tth script component 214 directs one or more scripts 220 to a Tth single storage location 222.

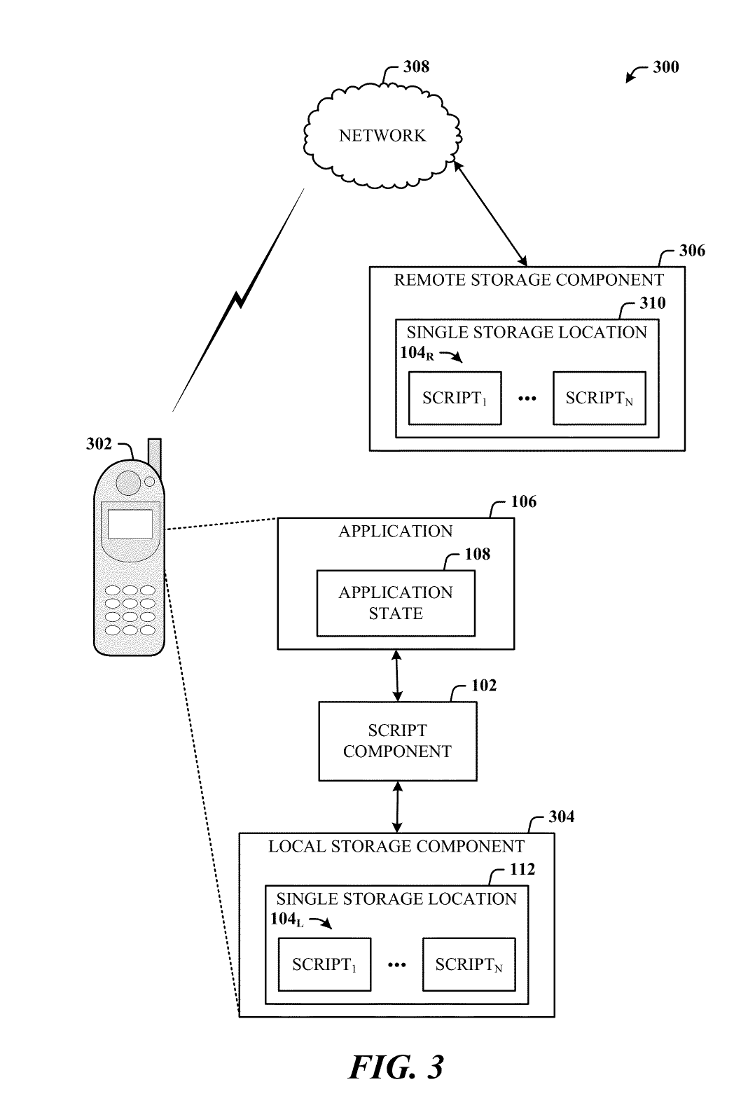

FIG. 3 illustrates a system 300 where a mobile device 302 employs the scripting and storage of application state. The mobile device 302 can include the system 100 of FIG. 1, the application 106 and associated application state 108, the script component 102 for auto-creation of the scripts 104_{L} (L for locally stored) of the state 108, and the storage component 110 as a local storage component 304. In this embodiment, the scripts 104_{L} are created and stored locally in the single storage location 112.

Alternatively, or in combination therewith, the scripts 104 can be stored remotely in a remote storage component 306 at scripts 104_{R}, connected to a network 308 (e.g., wireless, cloud, etc.), in a remote single storage location 310 that is identifiable and associated with the mobile device 302. Thus, the scripts 104_{L} stored locally can be updated from the scripts 104_{R} of the remote storage component 306, and the scripts 104_{R} of the remote storage component 306 can be updated from the scripts 104_{L}. In this example, the script component 102 can be configured to automatically create and handle the scripts 104 for both storage locations (112 and 310).

A user interface can be employed for manual script creation and user interaction, such as for reviewing the scripts in the single location, version information, and other data as desired.

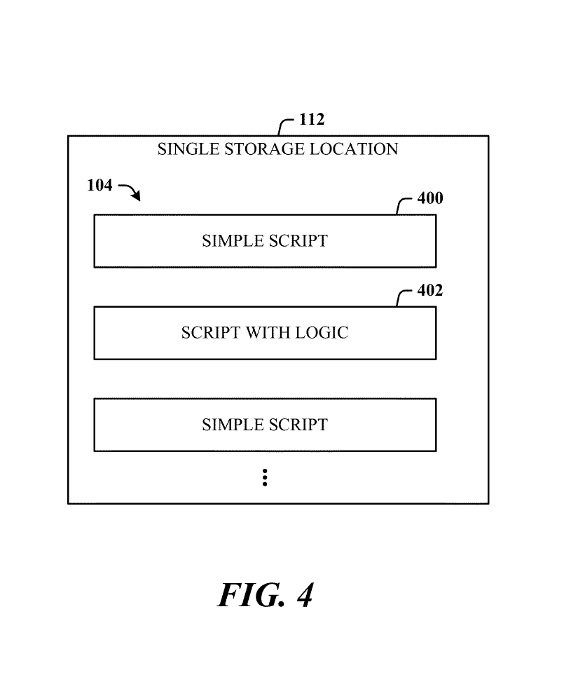

FIG. 4 illustrates the single storage location 112 that stores both simple scripts 400 and scripts with logic 402. As an example of a simple application state change, consider the desire to save the name of the user as part of the configuration. Rather than save the configuration file, the following script can be saved, where the user just provided the username “Winnie the Pooh”:

var config = application.getComponent(“Configuration”);
configuration.setUserName(“Winnie the Pooh”);
As soon as application starts, the application loads and runs all the saved scripts. Consequently, the username will be restored.

As an example of complex application state changes, consider that the restoration of the application state involves several steps. Scripts provide a degree of flexibility. The data that scripts contain does not have to be static. The scripts can also contain logic that synchronizes the data with the server(s) before reconstructing the actual application state, as shown below.

var config = application.getComponent(“Configuration”);
var numOfCPUs = configuration.getCPUCount( )
configuration.getModulelConfiguration( ).setThreadsCount(numOfC PUs * 2+2);
var module1 = application.getComponent(“Module1”);
module1.restart( );

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

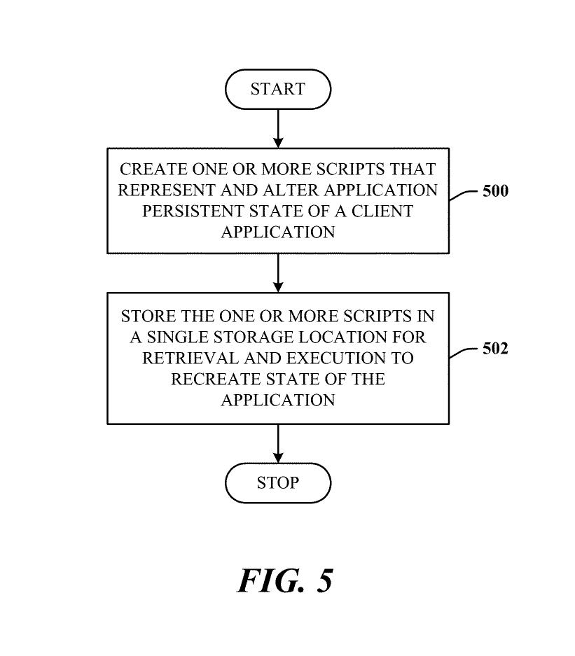

FIG. 5 illustrates a method in accordance with the disclosed architecture. At 500, one or more scripts are created that represent and alter application persistent state of a client application. At 502, the one or more scripts are stored in a single storage location for retrieval and execution to recreate state of the application.

The method can further comprise storing the one or more scripts in a single remote storage location accessible by the application to recreate the state. Thus, the scripts can only be stored solely in the remote storage location, solely in a local storage, or in the remote storage and the local storage.

The method can further comprise retrieving a script from the storage location and loading the script on the client to recreate prior application state and configuration of a given application. The script can be retrieved from local and/or remote storage.

The method can further comprise updating the one or more scripts to and from remote entities. The remote entities can include a cloud-based storage component, and another user computing system, for example.

The method can further comprise automatically generating the one or more scripts of an application, via the application. In other words, the application can include the script component for creating the scripts within the application.

The method can further comprise synchronizing a script before recreating application state of an application. The synchronization can be of other versions of the scripts, whether the latest scripts or a previous version of the scripts, and whether the scripts are local and/or remotely stored. The method can further comprise synchronizing a script with a server before recreating application state of an application.

The method can further comprise creating the one or more scripts with logic that executes are past of recreating the state of the application. The method can further comprise synchronizing state from scripts based on geolocation (geographic location) of the client application. That is, based on the coordinates of the mobile user device (e.g., via a geo-fence—a defined virtual perimeter the intersection of which causes certain events to occur), synchronization of the scripts can be automatically triggered for the purpose of some event. The event can be to receive the latest information or data for a given application (e.g., email, geographic location, etc.).

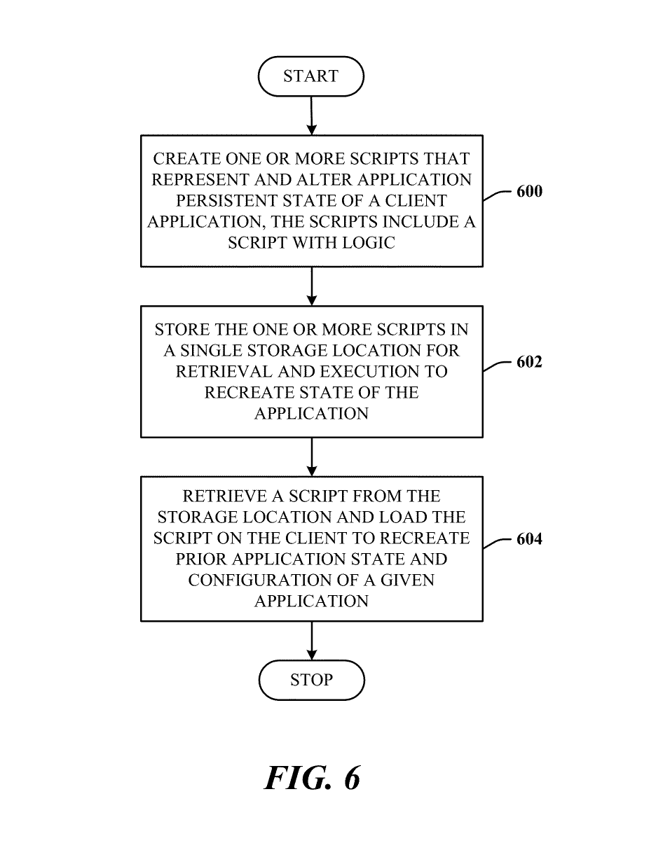

FIG. 6 illustrates an alternative method in accordance with the disclosed architecture. At 600, one or more scripts are created that represent and alter application persistent state of a client application. The scripts can include a script with logic. At 602, the one or more scripts are stored in a single storage location for retrieval and execution to recreate state of the application. At 604, a script is retrieved from the storage location and the script is loaded on the client to recreate prior application state and configuration of a given application.

The method can further comprise updating the one or more scripts to and from a remote storage component, and automatically generating the one or more scripts of an application, via the application. The method can further comprise synchronizing a script before recreating application state of an application, and loading the one or more scripts according to a predetermined order of execution. In other words, the state may need to be handled in a predetermined order for script creation, and thus, the reverse order of execution is followed in recreation of the application state.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

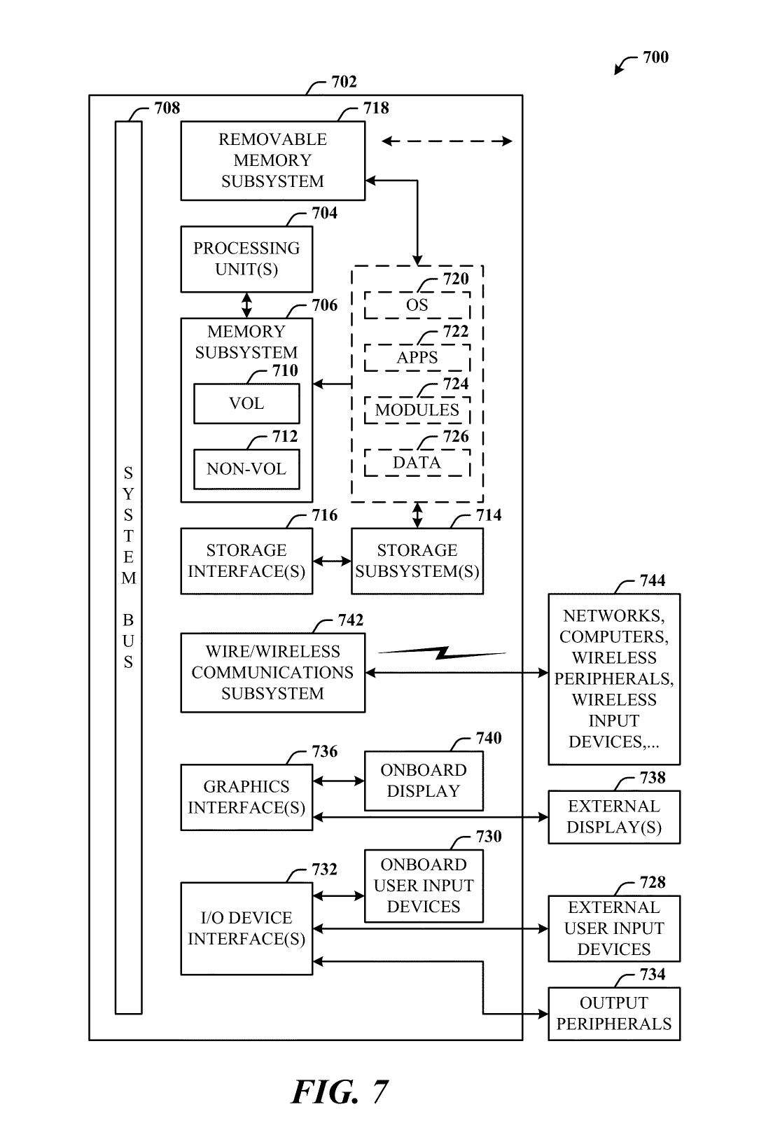

Referring now to FIG. 7, there is illustrated a block diagram of a computing system 700 that executes script creation and retrieval in a single storage location in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, entities and components of the system 300 of FIG. 3, the storage location 112 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 702, and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse. Other external user input devices 728 can include a microphone (for speech interaction), an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a script component that creates one or more scripts of an application that persists application state;
a storage component that stores the one or more scripts of the application as a single storage location for retrieval and execution to recreate the state of the application; and
a microprocessor that executes computer-executable instructions stored in a memory.

2. The system of claim 1, wherein the script component retrieves the one or more scripts from the single storage location and runs the one or more scripts to recreate the state of the application for application execution.

3. The system of claim 1, wherein the script component updates the one or more scripts from a remote entity.

4. The system of claim 1, wherein the script component synchronizes a script before recreating the application state of the application.

5. The system of claim 1, wherein the script component automatically creates a script to include logic, which logic executes when running the script.

6. The system of claim 1, wherein the script component creates scripts of application state for multiple applications and the storage component stores the scripts of a given application in a separate storage location.

7. A method, comprising acts of:
creating one or more scripts that represent and alter application persistent state of a client application;
storing the one or more scripts in a single storage location for retrieval and execution to recreate state of the application; and
utilizing a microprocessor that executes instructions stored in a memory.

8. The method of claim 7, further comprising storing the one or more scripts in a single remote storage location accessible by the application to recreate the state.

9. The method of claim 7, further comprising retrieving a script from the storage location and loading the script on the client to recreate prior application state and configuration of a given application.

10. The method of claim 7, further comprising updating the one or more scripts to and from remote entities.

11. The method of claim 7, further comprising automatically generating the one or more scripts of an application, via the application.

12. The method of claim 7, further comprising synchronizing a script before recreating application state of an application.

13. The method of claim 7, further comprising synchronizing a script with a server before recreating application state of an application.

14. The method of claim 7, further comprising creating the one or more scripts with logic that executes are past of recreating the state of the application.

15. The method of claim 7, further comprising synchronizing state from scripts based on geolocation of the client application.

16. A method, comprising acts of:
creating one or more scripts that represent and alter application persistent state of a client application, the scripts include a script with logic;
storing the one or more scripts in a single storage location for retrieval and execution to recreate state of the application;
retrieving a script from the storage location and loading the script on the client to recreate prior application state and configuration of a given application; and
utilizing a microprocessor that executes instructions stored in a memory.

17. The method of claim 16, further comprising updating the one or more scripts to and from a remote storage component.

18. The method of claim 16, further comprising automatically generating the one or more scripts of an application, via the application.

19. The method of claim 16, further comprising synchronizing a script before recreating application state of an application.

20. The method of claim 16, further comprising loading the one or more scripts according to a predetermined order of execution.
